(19) United States
(12) Patent Application Publication
(10) Pub. No.: US 2004/0220702 A1
(43) Pub. Date: Nov. 4, 2004

(54) Energy management system

(76) Inventors: Masahiro Matsubara, Hitachi (JP); Yasushi Harada, Hitachi (JP)

Correspondence Address: MATTINGLY, STANGER & MALUR, P.C., 1800 Diagonal Road, Suite 370, Alexandria, VA, 22301, US

(21) Appl. No.: 10/785,951

(22) Filed: Feb. 26, 2004

(30) Foreign Application Priority Data
Mar. 18, 2003 (JP) 2003-072908

(51) Int. Cl. G06F 1/26

(52) U.S. Cl. 700/291

(57) ABSTRACT

An energy management system that is easy to introduce and capable of effectively saving energy includes energy-related information input means for the input of energy-related information, energy-related information recognizing means for recognizing energy-related information, energy-related information storage means for storing energy-related information, and energy-related information analysis means for estimating information that has not been measured by analyzing the recognized energy-related information.

### BACKGROUND OF THE INVENTION

1. Technical Field

The invention relates to an energy management system, and more particularly to an energy management system suitable for buildings.

2. Background Art

In conventional systems for managing energy such as electric power in a building, the status of energy use is monitored by providing sensors such as ammeters at individual points where measurements are necessary, such as individual units, spaces for particular purposes, and feeders. In many cases, information transmission paths are also provided by means of dedicated lines.

A technique related to energy management is disclosed in JP Patent Publication (Kokai) No. 2001-265902 entitled “Environmental contribution evaluation system.” According to this technique, information about the use of individual PCs (personal computers) in a tenant of a building, such as information concerning their startup, shutdown and power consumption, and information about power consumption by various units are transmitted to a host server. The server organizes and stores the acquired data in a database, while presenting the data to the user together with standard values for comparison. The PC-use information is transmitted by client software installed on each PC. In addition, the system conducts an investigation by giving questions concerning user behavior, and present the user with the results in terms of numerical score representing the degree of environmental contribution.

In the conventional energy management systems, the more the number of measurement points, the more directly information necessary for energy management can be obtained. But an increase in the number of measurement points results in an increased cost and greater complexity in the energy management system. Accordingly, energy management systems with a large number of measurement points are introduced only into some of the large-sized buildings. On the other hand, simpler and less expensive energy management systems are only capable of handling information related to the electric power at the point of feeding, i.e. the power demand by a building as a whole, for example.

In terms of functionality, the existing systems go no further than rendering the acquired information into a database (“DB”) or graphs. Thus, it has been difficult to fully utilize the conventional energy management systems for energy-saving purposes.

It is therefore an object of the present invention to provide an energy management system that can be readily introduced and is effective for energy-saving purposes.

One of the features of the invention is that measured information related to energy consumption and sensory information indicating how an occupant is feeling about the lighting or air conditioning in the building are analyzed in a comprehensive manner. The information related to energy consumption includes measured values provided by various measuring devices attached to a building, information about the operation of equipment, information about the structure of the building or the facilities provided in the building, and weather information or measured values obtained in adjacent buildings, which can be obtained via an internet from the outside of the building. In this way, information that has not been measured can be obtained by calculation or deduction and used for energy management.

Thus, the costs incurred by measuring equipment or the installment thereof can be reduced relative to the type and amount of information that is obtained, so that an energy management system with a large cost effectiveness ratio can be realized. Particularly, such a system can be realized by utilizing information that can be obtained from the existing facilities.

Thus, it is one of the features of the present invention that information that is not available is inferred from available information. In addition to indirect control, the invention also places an emphasis on direct control or support thereof, such that the amount of energy consumption can be reduced by monitoring and improving the state of energy use. For this purpose, the analysis function provided by the invention can make a great contribution in terms of cost and functionality.

In another feature, the energy management system according to the invention includes energy-related information input means for the input of energy-related information, energy-related information recognition means for recognizing energy-related information, energy-related information storage means for storing energy-related information, and energy-related information analysis means for estimating information that has not been measured by analyzing the energy-related information that has been recognized.

Preferably, the energy-related information input means includes at least one of equipment operation information input means for the input of information relating to the operation of equipment, physical quantity measurement value input means for the input of information indicating the state of certain portions of the inside or outside of the building, or a change thereof, and occupant subjective input means for the input of information indicating subjective perceptions of a physical occupant.

Preferably, the energy-related information analysis means includes at least one of the following: purpose-by-purpose breakdown analysis means for analyzing the breakdown of the amount of energy use, such as electric power or electric energy, according to purpose; parameter estimation means for estimating parameters for calculation formulas relating to energy consumption, for the calculation of the amount of energy use, the amount of air-conditioning heat load, thermal circuit network, or electric power circuitry; physical quantity estimating means for estimating a physical quantity that has not been measured; equipment operation state estimation means for estimating the state of operation of equipment that has not been measured; numerical pattern estimation means for estimating a numeric pattern that can be expressed as a function relating to energy consumption and taking time as an argument, examples of such function including an equipment operation ratio, equipment load factor, the amount of energy use, and occupancy ratio; behavior estimation means for estimating the behavior of an occupant that relates to energy consumption, such as his behavioral characteristics or daily routine, in terms of attributes or automata that may vary with time; non-efficiency analysis means for estimating where and to what extent an inefficient use of energy exists and what the cause is; and spatial state estimation means for estimating the state of a space, such as the atmospheric temperature, the utilization rate of a room, or the effectiveness of air conditioning.

The energy management system of the invention may include a building equipment/unit database storing information relating to the building and its facility or equipment, such as the structure and attributes of the building and the specification of facility or equipment. In this case, the energy-related information analysis means can utilize the information stored in the building equipment/unit database in analyzing energy-related information.

Further, the energy management system of the invention may include analysis content input means for requesting or designating the content of processing by the energy-related information analysis means.

Further, the energy management system of the invention may include energy-related information display means for displaying energy-related information including the result of processing by the energy-related information analysis means.

Further, the energy management system of the invention may include equipment control means for controlling equipment related to the building, using the result of analysis by the energy-related information analysis means as an input.

Further, the energy management system of the invention may include energy-related information analysis possibility calculation means for calculating the type, amount or accuracy of information that is currently unknown but that can be newly estimated as a result of analysis, or information that can improve estimation accuracy, upon the input of the type or amount of energy-related information that is newly added or the energy-related information input means.

Further, the energy management system of the invention may include energy-related information necessity calculation means for calculating the type or amount of energy-related information that should be newly added or the energy-related information input means, or a point to be measured, upon the input by the user of the type of energy-related information that is currently unknown but that is desired to be newly estimated.

The energy-related information analysis possibility calculation means and the energy-related information necessity calculation means have the function of prioritizing the output from an economic viewpoint.

The energy management system of the invention may further include building administrator-side contact means for an administrator of a building occupant-side contact means, and building occupant-side contact means for an occupant of the building, so that the administrator and the occupant can send a request or a response between each other using the means.

The energy management system of the invention may employ a terminal such as a PC coupled to a network, as the energy-related information input means, so that the state of operation of each terminal can be inputted as equipment operation information. The input of equipment operation information from the terminal is carried out by software running on the terminal.

### BRIEF DESCRIPTION OF THE DRAWINGS

FIG. 1 shows the relationships among constituent elements in an embodiment of the invention.

FIG. 2 shows an example of the configuration of an embodiment of the invention employing PCs.

FIG. 3 shows an example of the structure of PC operation information.

FIG. 4 shows an example of PC operation information having a fixed field.

FIG. 5 shows an example of PC operation information expressed in XML.

FIG. 6 shows how power consumption that is contained in PC operation information is measured at certain time intervals.

FIG. 7 shows how power consumption that is contained in PC operation information is measured at varying time intervals.

FIG. 8 shows a flowchart for the estimation of purpose-by-purpose amounts of power consumption.

FIG. 9 shows a conceptual chart of illustrating a numerically expressed relationship between a PC startup ratio and the load factor of another equipment.

FIG. 10 shows a flowchart for expressing the relationship between the PC startup ratio and the load factor for another equipment in numerical terms.

FIG. 11 shows a flowchart for estimating parameters in thermal load calculation.

FIG. 12 shows a flowchart for the determination of presence or absence of wasteful use of energy.

FIG. 13 shows a flowchart for the determination of a change in efficiency in an air-conditioning system.

FIG. 14 shows a flowchart for the estimation of illuminance.

FIG. 15 shows a flowchart for estimating the CO₂ concentration and controlling ventilation equipment.

FIG. 16 shows a screen on which GUI for client software that runs on a PC is displayed.

FIG. 17 shows an example of display provided by the energy management system.

FIG. 18 shows an example of the configuration of an embodiment of the invention in which a plurality of buildings are managed via the Internet.

### DETAILED DESCRIPTION OF THE PREFERRED EMBODIMENTS

In the present specification, information necessary for energy management will be hereafter collectively referred to as “energy-related information.” Specifically, the energy-related information includes measured information related to energy consumption such as measurement values obtained by various meters, information about the operation of various units, information about the structure of the building or its facilities, and information that can be obtained via a network from outside of the building, such as weather information or measurement values obtained in an adjacent building. The energy-related information also includes information relating to an occupant's senses, such as how he or she feels about the lighting and/or air conditioning in the building.

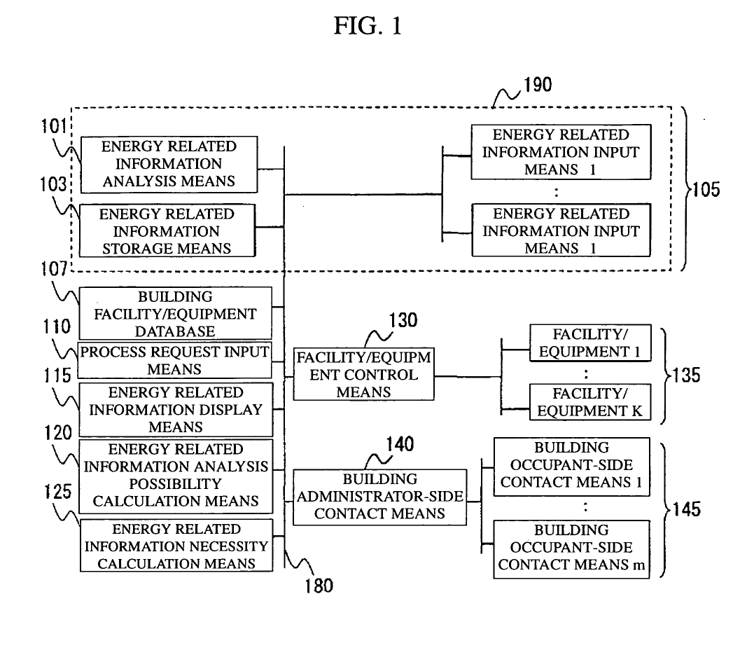

FIG. 1 shows an example of the configuration of an embodiment of the invention. A group 190 of elements is a minimum-required configuration, and it includes an energy-related information input means 105 for the input of energy-related information, an energy-related information storage means 103 for storing energy-related information, and an energy-related information analysis means 101 for estimating or deducing from the inputted energy-related information that has not been inputted.

Individual elements (101 to 145) are coupled via a communication line 180. The communication line 180 may be a serial cable, LAN, or the Internet, depending on the purposes of communication. It is, however, a bus when inside the same computer.

The energy-related information input means 105 includes at least one of an equipment operation information input means for the input of information relating to the operation of equipment, a physical quantity measurement value input means for the input of information indicating the state of certain portions inside and outside the building or a change thereof, and a subjective-information input means for the input of information indicating the subjective view of a physical occupant.

The energy-related information input means 105 is adapted to receive not only information about the inside of the building but also information about the outside thereof or the inside of an adjacent building.

The energy-related information inputted via the energy-related information input means 105 is analyzed by the energy-related information analysis means 101 either directly or after once stored in the energy-related information storage means 103.

The result of analysis by the energy-related information analysis means 101 is stored in the energy-related information storage means 103. The analysis result may be rendered into new energy-related information that can be used for analyzing other energy-related information.

Such is the flow of processes carried out by the elements in the minimum-required configuration. In the following, embodiments will be described in which there are constituent elements other than those minimally required.

A process-request input means 110 is used in requesting the energy-related information analysis means 101 to perform a process that is not predetermined. The energy-related information analysis means 101 determines whether or not a requested process can be conducted, and, if possible, conducts the requested process.

A building equipment/unit database 107 stores information relating to the structure or material of the building, or the performance or characteristics of various units or facilities. The energy-related information analysis means 101 refers to the building equipment/unit database 107 for data necessary for the analysis of energy-related information.

The result of analysis by the energy-related information analysis means 101 is stored in the energy-related information storage means 103, so that the user (administrator of the building and, in some cases, an occupant of the building) can see the analysis result on an energy-related information display means 115. The user can also refer to the energy-related information storage means 103 for energy-related information prior to analysis by the energy-related information analysis means 101, or to the building equipment/unit database 107 for information.

A equipment/unit control means 130 controls equipment/unit 135 (a plurality of equipment/units 1 to k in the illustrated example of FIG. 1) based on the result of analysis by the energy-related information analysis means 101. Besides the measured information, deduced or estimated information is also inputted, so that the control can be carried out based on a large number of pieces of information. An operation-status monitoring device (including a communication device) accompanying the equipment/unit 135 can be made to function as an energy-related information input means 105.

The building administrator can be informed of the result of analysis by the energy-related information analysis means 101 via the energy-related information display means 115. Based on the result, the administrator can transmit a notice or a request concerning energy management from a building administrator-side contact means 140 to building occupant-side contact means 145 (1 to k, in the example shown in FIG. 1). A building occupant who has received such a notice or request can respond, via the building occupant-side contact means 145, to the building administrator, via the building administrator-side contact means 140. Conversely, the building occupant may send a request to the building administrator, who can then respond to the request.

The process request input means 110 can also issue a process request to an energy-related information analysis possibility calculation means 120 and an energy-related information necessity calculation means 125.

A process request sent to the energy-related information analysis possibility calculation means 120 contains the type and amount of energy-related information or energy-related information input means that is newly added. Based on that information, the energy-related information analysis possibility calculation means 120 calculates the type, amount or accuracy of information that is currently unclear but that can be newly deduced or whose accuracy can be improved as a result of analysis.

A process request sent to the energy-related information necessity calculation means 125 contains the type of energy-related information that is currently unclear but that is desired to be newly estimated or deduced. Based on that information, the energy-related information necessity calculation means 125 calculates the type or amount of energy-related information or energy-related information input means that should be newly added, or the point where measurement should be made.

The user can refer to the energy-related information display means 115 for the result of calculation by the energy-related information analysis possibility calculation means 120 and that of the energy-related information necessity calculation means 125.

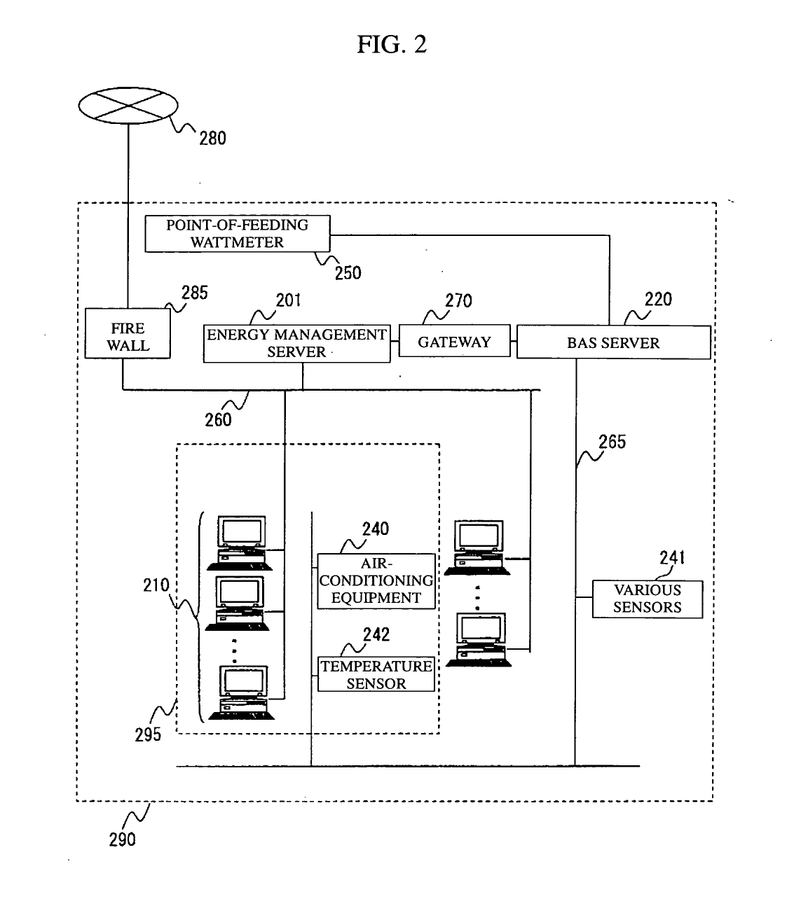

Now referring to FIG. 2, an embodiment of the invention will be described in detail, which is based on the assumption that the building is an office building where many PCs are being used. A estimated area 295 is a part of the building, such as one of the rooms of the office building, that delimits the space for energy management. The entirety of the office building 290 may also constitute the object of energy management.

An energy management server 201 functions as the central process unit of the energy management system. The energy management server 201 includes the functions of a variety of means shown in FIG. 1, namely the energy-related information analysis means 101, energy-related information storage means 103, building equipment/unit database 107, process request input means 110, energy-related information display means 115, energy-related information analysis possibility calculation means 120, energy-related information necessity calculation means 125, and building administrator-side contact means 140. Energy management software having the functions for energy-related information analysis, energy-related information analysis possibility calculation, and energy-related information necessity calculation is installed on the energy management server 201, in which there is also stored analysis rules, knowledge data and various standard values necessary for the energy-related information analysis function. The energy management server 201 is also built inside with a database of information relating to the structure or material of the building, and the performance or characteristics of equipment and facilities. The energy management server 201 is coupled to a LAN 260 by TCP/IP connection, and it is also connected via LAN 260 and a firewall 285 to the Internet 280.

The building is installed with a building automation system (BAS), which is coupled to all of the equipment/units of the building, such as those for air conditioning, lighting, anti-theft, anti-disaster, elevators, and parking. The BAS monitors and controls the operation of each of those units such that the operation of those units can be automated and management cost can be reduced.

The BAS includes a BAS server 220 as CPU, various units such as an air conditioning unit 240, various sensors 241 such as a temperature sensor 242, and various meters such as a point-of-feeding wattmeter 250. The BAS server 240 and other constituent units are connected by a BAS-dedicated serial line 265. The units connected to the BAS are equipped with means for detecting operation information and transmitting it to the BAS server 220, and means for performing controls by receiving a control instruction from the BAS server 220 and other units.

The BAS server 220 and the energy management server 201 are connected by a communication path via a gateway 270. The energy management server 201 is adapted to acquire from the BAS server 220 operation information about individual units and to issue a control instruction to the BAS server 220 for controlling individual units.

PCs 210 used inside the building are each coupled to the LAN 260 by TCP/IP connection. On each PC, a client can be operated in the form of software relative to the energy management server 201.

Upon startup of a PC 210, the client is automatically activated, beginning connection with the energy management server 201. The client monitors the operation status of its own computer and transmits the operation information to the energy management server 201 at certain intervals. Upon each occurrence of an event, including a startup and shutdown, information about that event is transmitted as it happens, or in bulk at the aforementioned time intervals. The interval of transmission may be either fixed or designated by the energy management server 201 for the clients. In the case where the PC operation information contains individual identification numbers, the energy management server 201 can be informed of the transmission interval for each client, so that each client can change the transmission interval on its own. When the transmission interval is changed, a new transmission interval is incorporated into the PC operation information. The transmission interval is determined by a method that is optimal in light of the contents of energy management or restrictions in the communication facility. With regard to the time duration of connection, it is appropriate to repeat connecting for each instance of transmission of PC operation information, as the energy management server 201 would be required to handle a great amount of load if connection is allowed for the entire duration of operation of the PC.

Hereafter an example of the information contained in the PC operation information will be described.

The PC operation information indicates at least whether or not a particular PC is activated. When the operation information is not that indicating the shutdown of a PC, the fact that the PC is connected to the energy management server 201 indicates that the PC is activated. Thus, even if the PC operation information does not contain other information, the fact that a PC is activated somewhere inside the building can be known.

The PC operation information may also contain individual identification numbers of the PCs or clients, so that the individual items of PC operation information can be distinguished. It is also possible to use the MAC address of a communication device used in IP communication, instead of the individual identification number of the PC or client.

The PC operation information can contain information about the location of each PC. The location information indicates the floor number of the building, the room number, the orientation (whether the particular location is toward north, south, west, or east), or is expressed in terms of the coordinates. When a plurality of buildings are under the management of the energy management server 210, the position information also contains information about the location of each building.

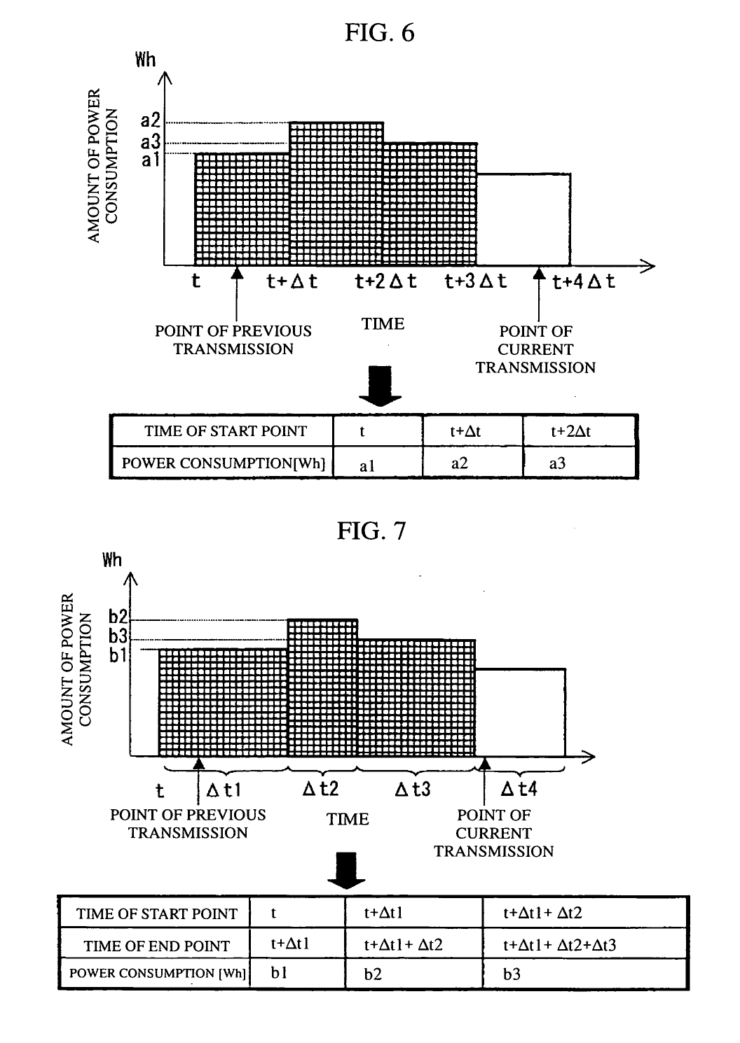

As shown in FIG. 6, the PC operation information can include information about power consumption a1 to a3 (Wh) in the main body of a particular PC at certain time intervals (Dt, such as 30 min intervals) between the previous time of transmission to the current time of transmission. Examples of similar power consumption information include the power consumption at the current time of transmission, an average power consumption between the previous transmission and the current time of transmission, and pairs of variable time intervals (Dt1 to Dt4) and corresponding power consumption b1 to b3 (Wh), as shown in FIG. 7. If the power consumption at various parts of a PC can be individually known, the PC operation information may include power consumption information for each part. The PC operation information may also include power consumption information regarding peripheral devices such as the display of the PC in the same manner as the power consumption by the PC main body.

The PC operation information can include attribute information about a PC or that about peripheral devices such as the display of a PC. The attribute information may involve the structure of a particular device, such as whether the display is a CRT display or an LCD, or whether the printer is an inkjet or a laser, and/or the nature of control, such as whether or not a screen saver is turned on, whether or not a power save mode is available during standby, or how much saving can be achieved in power consumption during power save mode in percentage terms.

The PC operation information may include information about the use of peripheral devices such as a printer, namely information about the type of the device that has been used or is being used, or how the device operates.

The PC operation information may include information about the CPU utilization rate or the frequency of use of input devices such as a keyboard or mouse. The PC operation information may also include information about the operation status of the PC that is deduced from the aforementioned information. The operation status may indicate either “normal” or “idle,” for example, the latter being deduced when an input device is not in use for a certain duration of time, for example.

The PC operation information may include information indicating the activation or deactivation of a screen saver.

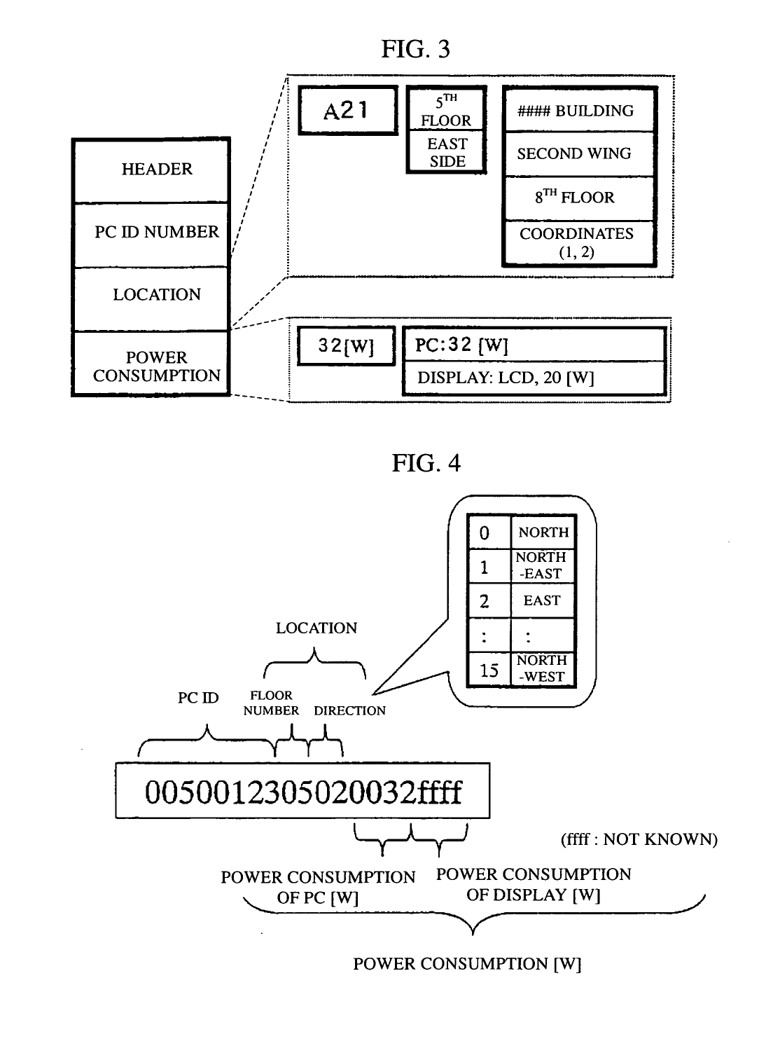

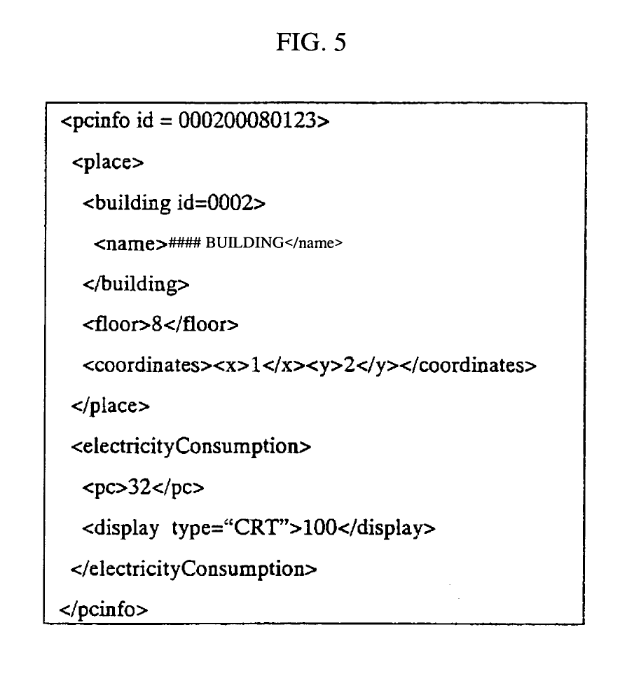

FIG. 3 shows an example of the structure of the PC operation information. The illustrated structure includes header information, information about the ID number of a PC, information about the location of the PC, and information about the power consumption by the PC. Even within the same type of information, the expression or the degree of detail may be varied. FIG. 4 shows an example in which the PC operation information is realized in a fixed field. In this example, the PC operation information includes information about the ID number of a PC, information about the location of the PC, namely information about the floor number and orientation, and information about power consumption, namely the power consumption by the PC (W) and that by the display (W; expressed as “ffff” or in any other arbitrary manner when unknown). FIG. 5 shows another example where similar information is expressed in XML (extensible Markup Language).

Immediately prior to shutting down PC, the client notifies the energy management server 201 of that event, so that the energy management server 201 can recognize the shutdown of the PC. In cases where the client cannot make such a notification, as when the PC shuts down abnormally, the energy management server 201 is adapted to recognize the shutdown of the PC upon termination of connection with the client.

Such is the manner in which information necessary for energy management and for the estimation or deduction of unclear information is gathered, based on which information various equipment/units are controlled through BAS.

In offices nowadays each employee is commonly provided with his or her own PC, and it is possible to monitor the detailed operation status of each PC in a given building. The operation of such PCs is linked with the activity of the occupants of the building and is closely related to energy consumption.

In order to acquire PC operation information, it is only necessary to run a client on the PC, and there is no need to newly mount sensors or a communication unit. For the transmission of information, a communication path such as LAN or the Internet is employed. These transmission paths are in many cases already laid out inside the building. If they are not, there are more advantages to be gained by laying out such communication paths, in light of their versatility. Thus, both the initial and running costs can be minimized.

While the client software must be installed on each PC, there is more motivation for the user to do the installing as energy management is an environmental issue.

The manner in which data is registered on the building equipment/unit DB can be divided into two categories, namely a method in which data contained in energy-related information is registered as needed, and another method in which the data is registered from the outside, namely directly in the energy management server, by the system or building administrator. In the former case, information about the rated power consumption of each device or unit is registered in the building equipment/unit DB upon initial acquisition of that information by the energy management server from the PC or BAS. Thus, when transmitting or receiving subsequent energy-related information, the rated power consumption or, in the case of devices with constant-power characteristics, the power consumption at individual points of time, can be omitted. Upon initial startup, the client on the PC displays GUI for the input of attributes such as the location information, and such information is transmitted to the energy management server for registration when the PC user (occupant) enters that information. In this way, the location information or the like can be accessed on the part of the energy management server as long as the individual identification number of the client is available.

In the following, the analysis of energy-related information in the embodiment shown in FIG. 2 will be described. The analysis involves, for example: the estimation of the breakdown of the amount of energy consumption, such as energy consumption at the point of feeding, according to individual purposes; the estimation of the parameters of expressions that represent the heat load of air conditioning applied in a space of interest, or the amount of energy consumption in a space of interest; the estimation of physical quantities that have yet to be measured or the operation status of a unit from which no operation information has been acquired; determination of optimum facility or unit and operation based on the estimation and calculation about how much room is there for saving of energy or how the amount of energy consumption varies if a unit is replaced or an operating method is changed; the identification of units or method of using units that are responsible for a reduced efficiency, waste or abnormality in energy consumption, and what their causes are; the monitoring of the utilization rate of rooms or the state of rooms including that of an air conditioner, for example; the calculation and monitoring of correlations among individual items of energy-related information; the monitoring of the daily routines of occupants that are closely related to energy consumption; and the calculation of basic units based on estimated values and their comparison with standard values.

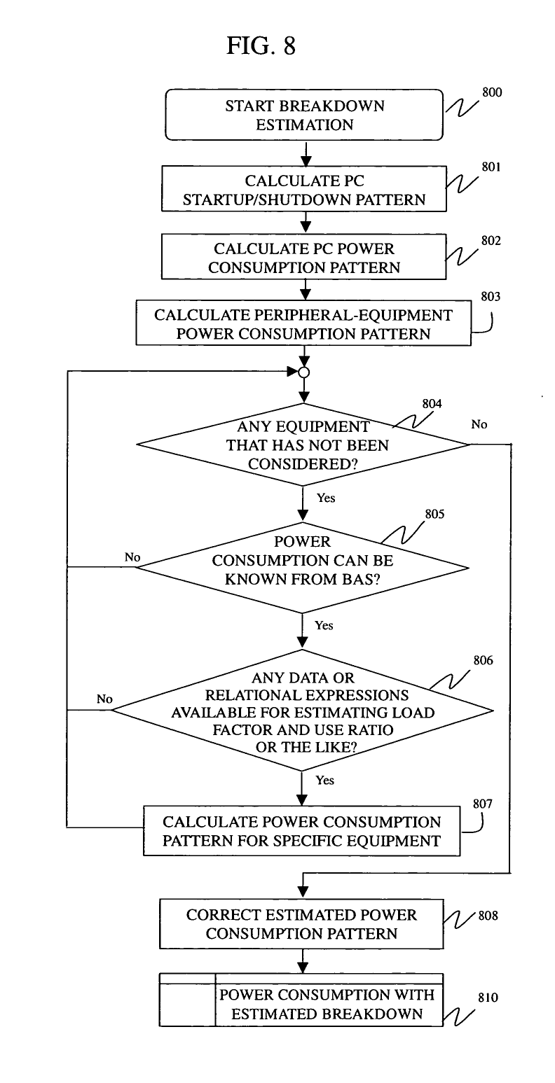

FIG. 8 shows a flowchart illustrating the process of estimating the breakdown of power consumption in the estimated area 295 for estimating how much energy is consumed by which unit. In step 800, the breakdown estimation process begins. In step 801, a startup/shutdown pattern of PCs is calculated based on the PC operation information collected periodically. In step 802, in case the PC operation information does not contain the power consumption information, the PC power consumption pattern is calculated based on the startup/shutdown pattern obtained in step 801 by making reference to the PC rated-power consumption data stored in the building equipment/unit DB.

In step 803, a power consumption pattern for peripheral equipment is calculated. If the PC operation information contains the power consumption by peripheral equipment, that information is utilized. If the peripheral equipment that is used, such as a printer, and the content of process such as printing process are contained in the PC operation information, the power consumption pattern of that process is obtained from the building equipment/unit DB. If there is an inherent value for a particular peripheral unit, that values is used; if not, standard value for a unit of the same type is used. In the absence of a notification when the setting is such that a notification should be made via PC operation information whenever some processing is conducted by the peripheral unit, it can be judged that the power consumption by that peripheral unit is either zero or equal to standby power consumption.

In steps 804 to 807, the power consumption patterns of all of those units other than PCs that render themselves to estimation based on the startup/shutdown patterns or power consumption patterns of PCs are calculated. In step 804, a unit in the energy-management target area for which no determination as to the possibility of estimation of power consumption pattern has been made is selected. In step 805, it is determined whether or not the power consumption of the unit selected in step 805 can be acquired from BAS. If not, it is determined in step 806 whether or not there is data necessary for the estimation of power consumption pattern of the selected unit. If there is the necessary data, the power consumption pattern of that unit is estimated in step 807.

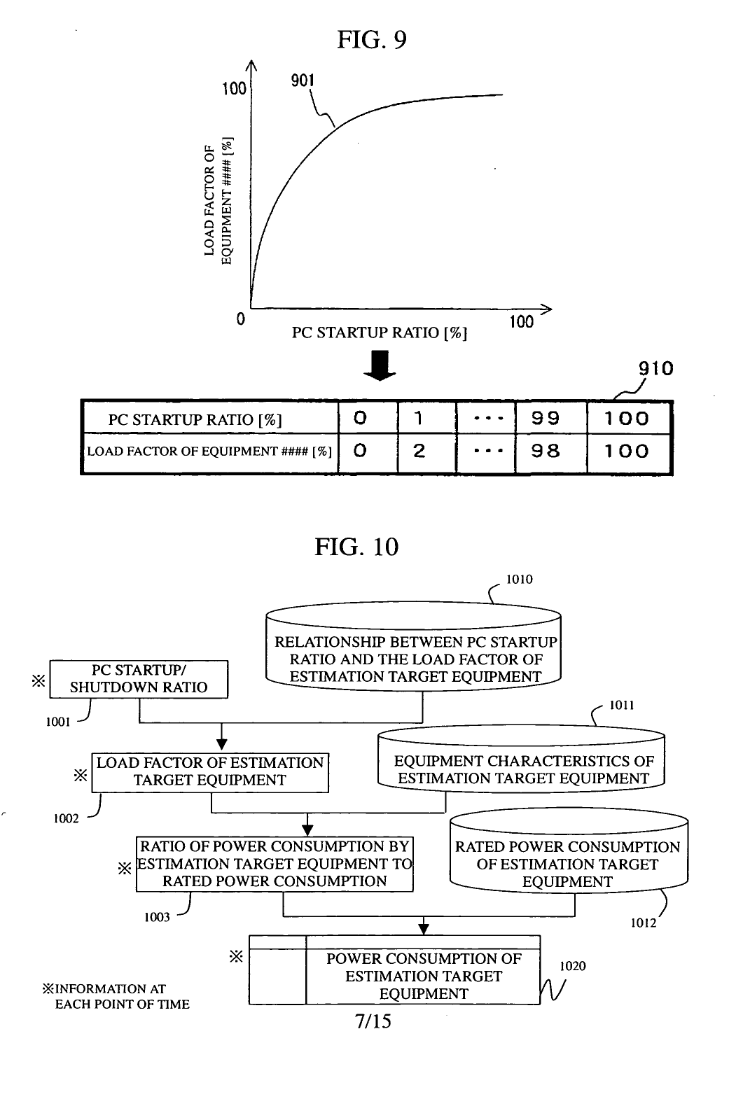

In step 807, the relationship between the startup/shutdown pattern (or power consumption pattern) of PC and the use ratio (or load factor) of other equipment such as lighting equipment is monitored in terms of a mathematical expression or table data 910 indicating the relationship between the PC startup ratio (%) and the load factor (%) of a certain unit, as shown in FIG. 9. A curve 901 indicates the relationship between the PC startup ratio (%) and the load factor (%) of the certain unit. Preferably, the equipment volume or rated power consumption of each unit may also be stored in the building equipment/unit DB. Further, if the startup/shutdown pattern of a PC is known, the power consumption pattern of each unit can be calculated from the aforementioned two kinds of data, as shown in FIG. 10. Data 1010 regarding the relationship between the PC startup ratio and the load factor of the estimation target unit is similar to the table 910. Based on PC startup/shutdown ratio data 1001 indicating the PC startup/shutdown ratio against the time axis and the data 1010, a load factor pattern 1002 of the estimation target unit can be determined. Device characteristics data 1011 of an estimation target device indicates the power consumption at a given load factor relative to a rated power consumption, the relationship being expressed in the same manner as in the data 1010. Based on the load factor pattern 1002 and the data 1011, a pattern 1003 of the ratio of the power consumption by the estimation target device to a rated power consumption can be determined. Based on this and a rated power consumption 1012 of the estimation target device, a power consumption pattern 1020 of the estimation target device can be determined. When the estimation target consists of a plurality of devices, the facility volume can be determined instead of the rated power consumption 1012. The data 1010 to 1012 and the facility volume are stored in the building equipment/unit DB. The data 1001 to 1003 and 1020 is information at each points of time.

The data or relational expression as shown in FIG. 9 are preferably obtained by conducting a regressive analysis on actual measurements taken in a certain period, or provided by standard data. Such measurements may be taken using a portable wattmeter, for example, so that the obtained information can be later fed into the energy management server for analysis. Preferably, the PC operation status and other variables such as the startup/shutdown of a screen saver, and the seasons or temperatures may be incorporated into analysis, in order to improve the precision of management. In that case, variables such as data in BAS is utilized.

By thus subtracting the measured or estimated power consumption from the point-of-feeding power, the amount of power being used for purposes that has not been estimated approaches zero at the end of the loop of steps 804 to 807.

In step 808, the estimated power consumption pattern is corrected. The electric power in the estimated area 295 (or the electric power at the point of feeding if the estimated area is the entire office 290) is measured via a feeder, for example, and then compared with the sum of the amount of power consumption obtained from BAS for each unit and the estimated power consumption amount. If there is a difference between them, the estimated power consumption must be corrected by, for example, multiplying each estimated power consumption with the quotient of {(entire power consumption)−(sum of power consumption amounts obtained from BAS)}/(sum of estimated electric power amounts).

If the amount or margin of correction in step 808 is too large, it can be determined that the unit efficiency is lowered or that there is an abnormality. A similar conclusion can be drawn if a large discrepancy is found between a measured value and an estimated value of that measured value which is estimated from other measured values. Deduction rules for the determination of causes are provided, so that a cause can be determined based on various determination factors such as the correction amount or margin of the estimated value of the amount of energy used, the equipment operation information and/or equipment failure information from BAS, and so on. If necessary, questions may be asked of the user (building administrator).

By the aforementioned calculations, power consumption 810 of which a breakdown is estimated is obtained with regard to the estimated area 295. By thus estimating the purpose-by-purpose breakdown of the consumption of energy such as electric power or gas in an estimated area, it becomes possible to conduct energy management for each unit or each electric line without providing sensors as required in the conventional energy management system for measurement.

By estimating the purpose-by-purpose energy use amount, calculating the base unit, and comparing the base unit with a standard base unit, it can be known which base unit has increased. The analysis is conducted from a variety of viewpoints, including the time of day, the season of year, the occupancy ratio, and the type of work. Based on these comparisons, the daily routine pattern of the estimated area can be determined, such as whether the area tends to waste energy, or whether the area has a large air-conditioning load due to an extended overtime work with the air conditioner on, for example. Thus, a finer control can be effected.

In the energy management system shown in FIG. 2, in addition to the estimation of a breakdown, it is possible to estimate the energy consumption amount or the parameters of heat of air conditioning from the energy consumption amount measured or estimated in each unit. The amount of energy consumption can be calculated by conducting a multiple regression analysis or a neural network learning on measured or estimated values.

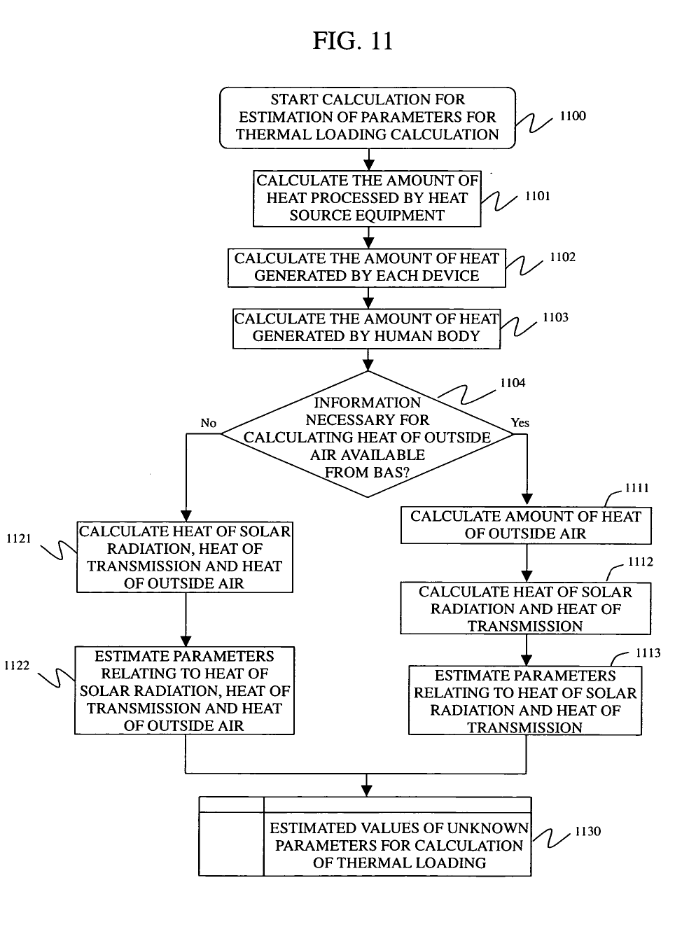

FIG. 11 shows a simple example of a method of parameter estimation for thermal load calculation. In this example, the thermal load factors include the heat of solar radiation, the heat of transmission, the heat of outside air, the heat generated by equipment, and the heat generated by the human body. In step 1100, the process of parameter estimation calculations for thermal load calculation starts. In step 1101, the processed heat amount of a heat source equipment is calculated from the measured or estimated amount of energy consumption by the heat source equipment. In step 1102, the amount of heat generated in each unit is calculated from the measured or estimated amount of energy consumption in each unit. In step 1103, the occupancy ratio of the estimated area is estimated as in the estimation of energy consumption in each unit based on the PC operation information. In addition, the type of activity of the occupants and the amount of accompanying heat generation are determined based on the purpose of the building as stored in the building equipment/unit DB, in order to calculate the amount of heat generated by the human bodies. In step 1104, it is determined whether or not information (such as the operation information about air blowers or ventilating fans) necessary for the calculation of the heat of outside air can be acquired from BAS. If it can be acquired (Yes), the routine proceeds to step 1111 where the amount of the heat of outside air is calculated. If not (No), the routine proceeds to step 1121. In step 1112, the heat of solar radiation and the heat of transmission are calculated. In step 1121, the heat of solar radiation, the heat of transmission and the heat of outside air remain unclear. These amounts are calculated based on the fact that their sum is equal to the amount of processed thermal load of the heat source equipment in step 1101 from which the heat of equipment in step 1102 and the heat generated by human body in step 1103 and, in case the routine proceeded to step 1111, the heat of outside air have been subtracted. In step 1113 or step 1122, thermal load calculation parameters necessary for the calculation of the heat of solar radiation or the heat of transmission are estimated by multiple regression analysis, for example. The estimated parameters include the amount of solar radiation, the outside temperature/humidity, inside temperature/humidity, and the wall heat transmission coefficient. The estimation is conducted after minimizing the number of parameters that are unclear and therefore must be estimated, by utilizing parameters that are available from BAS or the building equipment/unit DB. By conducting these calculations, estimated values of unclear parameters for thermal load calculation can be obtained in step 1130.

The energy management system shown in FIG. 2 can also calculate the amount of energy that can be potentially saved. Once the energy consumption by each unit can be estimated by the procedure illustrated in FIG. 8, the energy consumption that would result if the units are replaced by high-efficiency units can be estimated and thus the potential energy saving margin can be calculated. In this case, equipment data concerning the energy utilization rates or the like of the current equipment and the high-efficiency equipment is stored in the building equipment/unit DB.

Further, the energy saving margin can be calculated from the attribute information about peripheral devices. In the case where the display is a CRT, the amount of energy saving that could be achieved by replacing the CRT with an LCD can be calculated by subtracting the electric power consumption of a standard LCD as stored in the building equipment/unit DB from the power consumption of the current CRT display or its standard value obtained from the PC operation information or the building equipment/unit DB.

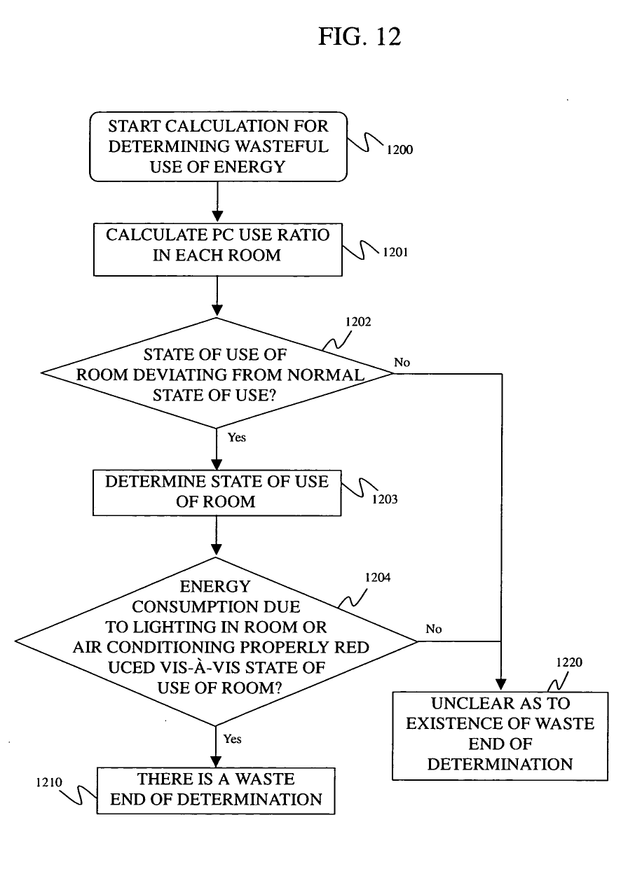

FIG. 12 shows an example of the procedure for determining if there is any wasteful use of energy. In step 1200, a calculation for identifying a wasteful use of energy is started. In step 1201, based on the information about the startup/shutdown of the screen savers of PC that are activated in connection with the startup/shutdown of PC, and the information about the use of input devices such as keyboards and mice, the PC use ratio for each room is calculated. In step 1202, it is determined that the state of use of the room is out of ordinary (Yes) when the rate of drop of the PC use ratio with reference to an average use ratio during the work hours exceeds a threshold value. In step 1203, the state of use of the room, such as “lunch break” or “in meeting,” is determined in light of the hour of day, for example. When it is determined that the state of use of the room is irregular, such as “lunch break” or “in meeting,” the rate of drop of the PC use ratio is compared in step 1204 with the rate of drop of the electric power consumption by lighting or air conditioners from a regular state of use of the room. If the latter rate of drop is relatively small (Yes), it is determined in step 1210 that there is a waste in the manner of using energy. The cause of waste could be determined from the type of energy of which the drop rate is relatively small to be the fact that lights are unnecessarily on during lunch break, that there are some lights on in unused spaces during overtime work, or that too much air-conditioning is provided for only a very few people working overtime. For this determination, the device operation information from BAS is utilized as auxiliary information.

Hereafter examples of estimation of the state of rooms or devices will be described, in addition to the determination of the presence or absence of wasteful use of energy as described with reference to FIG. 12.

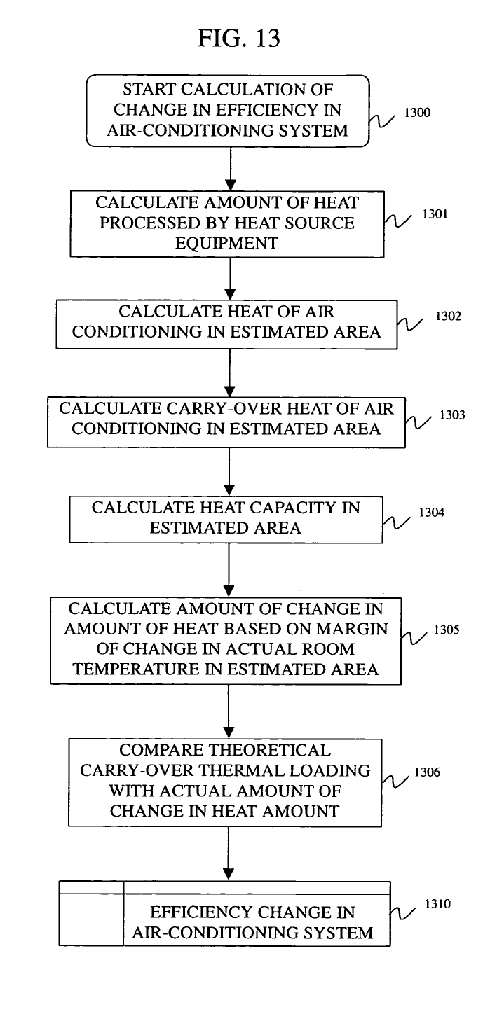

FIG. 13 shows an example of the calculation of changes in the efficiency of an air-conditioning system. In step 1300, the process of calculating efficiency changes in the air-conditioning system starts. In step 1301, the amount of thermal load processed by the heat source equipment is calculated from energy consumption, as in step 1101. In step 1302, while monitoring all of the parameters for thermal load calculation for the estimated area 295, the heat of air conditioning generated in the estimated area is calculated. In step 1303, a carry-over heat of air conditioning in the estimated area is determined by subtracting the heat of air conditioning in the estimated area from the processed heat amount of the heat source equipment. In step 1304, the thermal volume of the room is calculated by acquiring the dimensions of the estimated area from the building equipment/unit DB. In step 1305, the amount of change in the thermal amount of the estimated area is calculated from actual temperature changes and thermal volume of the estimated area. In step 1306, the theoretical carry-over heat amount calculated in step 1303 is compared with the actual amount of change in the heat load, in order to calculate a change in efficiency of the air conditioning system and to determine if there is any efficiency deterioration. Thus, in step 1310, a result can be obtained indicating any changes in the efficiency of the air conditioning system.

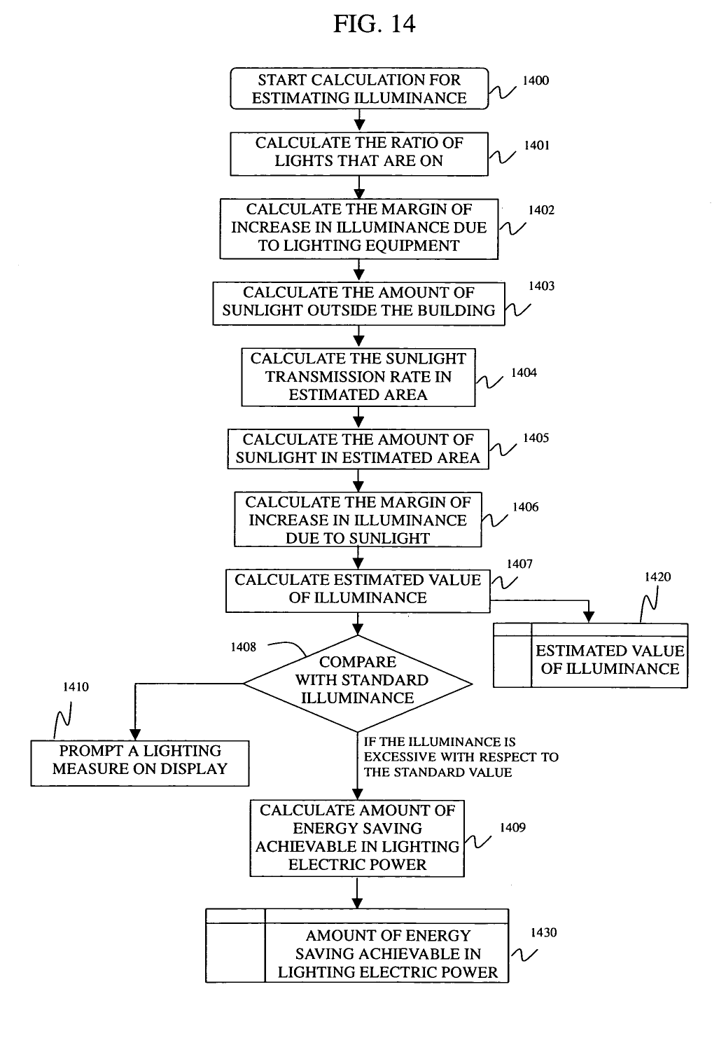

FIG. 14 shows an example of a method of estimating the brightness of a room or determining the appropriateness of such estimation. In step 1400, the process of calculating an illumination estimation is started. In step 1401, a lighting-on ratio is either acquired from BAS or estimated from the PC operation information. In step 1402, the amount of light flux or structure of a lighting device, the presence or absence of use of daylight, the color of the walls of the estimated area, and so on are obtained from the building equipment/unit DB, in order to calculate how much increase in luminance is provided in the estimated area by the lighting device. In step 1403, based on the relationship between the time and the amount of sunlight that has been investigated in advance, the amount of sunlight outside the building is calculated. In step 1404, the ratio of window area, for example, is acquired from the building equipment/unit DB, and the ratio of sunlight transmission, which is the ratio of sunlight that enters the estimated area, is calculated. In step 1405, based on the amount of sunlight calculated in step 1403 and the solar transmission ratio obtained in step 1404, the amount of sunlight that enters the estimated area is calculated. In step 1406, the increase in illuminance due to sunlight is calculated by using such information as the color of the wall acquired in step 1402. In step 1407, based on the result of steps 1402 and 1406, the illuminance of the estimated area is estimated to obtain an estimated value 1420 of the illuminance of the estimated area. In step 1408, the purpose of the room is acquired from the building equipment/unit DB, and from the purpose of the room is in turn acquired the standard illuminance of the room, so that it can be determined whether or not the estimated illuminance obtained in step 1407 is appropriate. If the illuminance is determined to be too small, an indication is made in step 1410 prompting the provision of more illumination. If, on the other hand, the illuminance is determined to be excessive, the routine proceeds to step 1409 where, based on the current illumination electric power provided in the estimated area, and in light of the ratio of the current illuminance to standard illuminance or the energy-saving ratio in the case of using daylight, the energy-saving margin in illumination electric power is calculated to obtain a possible energy-saving amount 1430 in illumination electric power. The current illumination electric power may be either a measured value or an estimated value.

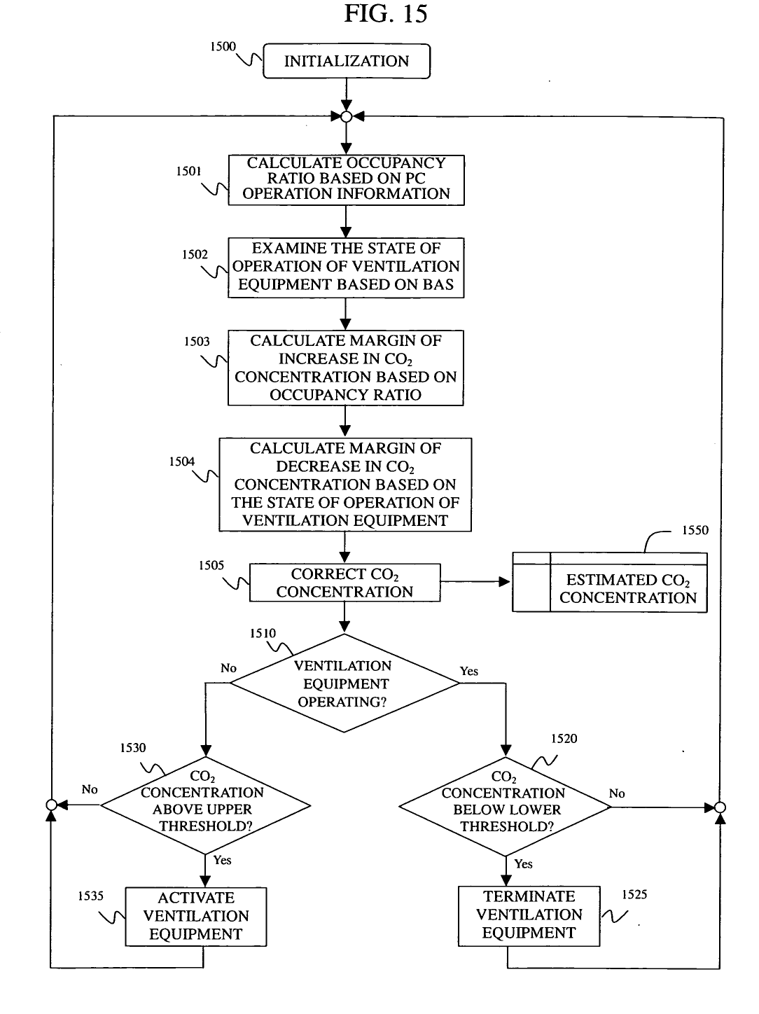

FIG. 15 shows an example of the manner in which it is estimated to see whether a degree of air cleanliness is maintained and how ventilation is controlled based on the estimation of air cleanliness. In step 1500 for initialization, it is assumed that the CO₂ concentration in an estimated area is equal to that of the atmosphere. In step 1501, from which the subsequent steps are performed at certain time intervals, the occupancy ratio is calculated from the PC operation information. In step 1502, the operation state of ventilation equipment is determined from BAS. In step 1503, the margin of increase in CO₂ concentration, which is proportional to the occupancy ratio and inversely proportional to the dimensions of the room, is calculated from the type of activity of the occupants. In step 1504, the margin of decrease in CO₂ concentration due to ventilation equipment and draft, which decrease is proportional to the capacity of ventilation equipment and inversely proportional to the dimensions of the room, is calculated. The amount of draft is estimated or inferred from the structure of the estimated area, for example. In step 1505, it is determined whether or not the CO₂ concentrations calculated in steps 1503 and 1504 violate restrictions concerning the upper or lower limit values (such as the CO₂ concentration of the atmosphere). Any violation there is corrected. In this manner, the CO₂ concentration 1550 of the estimated area at each point in time is estimated.

Based on the thus estimated CO₂ concentration, the ventilation equipment is controlled. In step 1510, based on the information from BAS that has been obtained in step 1502, it is determined whether the ventilation equipment is operating or not. If the ventilation equipment is not operating (No), it is determined in step 1530 whether or not the CO₂ concentration exceeds a threshold at which it is determined that ventilation is necessary. If the threshold is exceeded (Yes), BAS is instructed to activate the ventilation equipment in step 1535. If the ventilation equipment is operating (Yes), it is then determined whether the CO₂ concentration is lower than a threshold at which it is determined in step 1520 that no ventilation is necessary. If the threshold is not reached (Yes), BAS is instructed to terminate the operation of the ventilation equipment in step 1525.

Thus, by activating the ventilation equipment only when necessary, energy saving can be achieved without compromising a level of comfort and without using any CO₂ concentration sensors. If the ventilation equipment is equipped with an inverter and therefore capable of adjusting the amount of ventilation, the ventilation amount may be controlled in accordance with CO₂ concentration.

In the energy management system shown in FIG. 2, energy management is conducted based on how the occupants of the building are feeling. In other words, the occupants are being used as sensors. In the following, the utilization of information relating to the subjective judgments of the occupants of the building will be described.

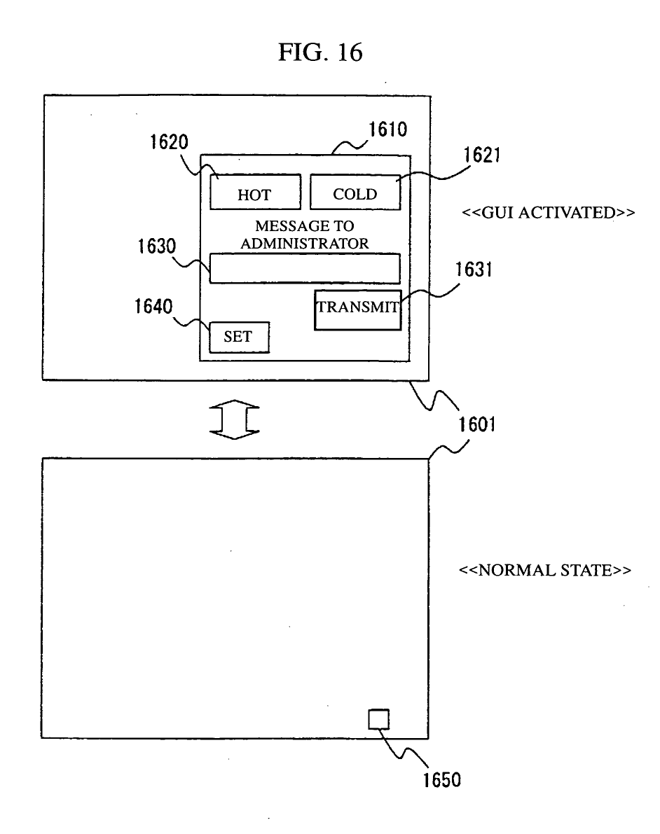

Referring to the upper portion of FIG. 16, the building occupants' subjective information is entered via GUI. The subjective information may be centered around perceptions relating to air conditioning, such as “Hot” 1620 and “Cold” 1621, so that the information can be utilized for energy management purposes. The occupants of a building typically input their subjective information when they want to let the building administrator know that they think the room is either too hot or cold. In such a case, a PC-using occupant of the building pushes a GUI activation button that is usually displayed at a small size at a corner of his or her computer screen, as shown the bottom of FIG. 16 indicating “NORMAL STATE,” thereby causing a display 1610 for GUI activation to appear. After making an entry into a column 1630 for sending messages to the administrator, the occupant presses a transmission button 1631 to complete the transmission. It should be noted, however, that the administrator of the building can modify the subjective information input items from his or her server. Namely, the administrator has the liberty of selecting the type of questions to be answered by the occupants, so that he can be informed of the kind of occupants' perceptions necessary for analyzing energy-related information when he needs it. The building occupants, however, can choose a setting by pressing a button 1640 such that they can refuse to answer the questions selected by the administrator.

In the existing air-conditioning systems or energy management systems, whether or not an air-conditioner is working fine is determined by examining, for example, if the room temperature as measured by a temperature sensor is in keeping with the operation setting of the air-conditioner. In the energy management system according to the present embodiment of the invention, whether the air-conditioner is working properly or whether the temperature that is set is proper is determined by learning how the occupants are feeling, i.e., such as “hot” or “cold”. In addition, the administrator must respond differently between the case where many people are saying it is hot and the case where the same person is saying it is hot repeatedly. In the case of the former, i.e. when many occupants are saying it is hot, the energy management server makes a decision to, for example, lower the air-conditioning set temperature by 1° C., and gives an instruction to BAS, thus notifying the administrator of the need via display. In the case where the same individual is saying it is hot repeatedly, the energy management server determines that there is a possibility that the effect of the air-conditioner is felt only locally and that, if that is the case, the design of the air-conditioning facility must be reviewed, and then notifies the administrator of that fact via display.

By thus controlling the air-conditioner such that the number of complaints from the occupants, such as it is too hot or cold, can be minimized, and the occupants can feel most comfortable, too much or too little air-conditioning can be prevented without requiring temperature sensors, thus contributing to energy management. Also, the relationship between the occupancy ratio and the appropriate air-conditioning output can be monitored.

In cases where a task-ambient air-conditioning is provided, the task air-conditioning is adjusted for individuals who are complaining of hotness or coldness, and the ambient air-conditioning is adjusted if there is a general complaint about air-conditioning among the entire occupants, thus optimizing the operation of the air conditioner.

In a case where the building occupant subjective information indicates that there is not enough air-conditioning but the electric power being spent for air conditioning is more than an appropriate level according to BAS information or other estimates, it can be estimated or inferred that there is an energy loss in air conditioning. In that case, if the appropriate level is based on the past statistics in the estimated area and if the increase in air-conditioning electric power is accumulating over the years, it can be inferred that the loss is due to a reduction in equipment efficiency. If the appropriate level is a standard value, it can be inferred that there might be problems possibly in the structure of the building or the ejection outlet of the air conditioner. The air-conditioning electric power used for comparison with the appropriate level is corrected in light of variation factors such as outside temperature. The energy management server has a deduction rule for making such inferences.

In cases where it is possible to obtain measured values of outside temperature and humidity, the relationship among the outside temperature/humidity, the room temperature/humidity, and the predicted mean vote (PMV) by the occupants is examined and monitored, so that the room temperature/humidity can be inferred from the outside temperature/humidity and the occupant PMV. The occupant PMV can be calculated from the building occupant subjective information. Those who do not come forward with opinions can be judged to be feeling comfortable.

The job of the building administrator can be divided into energy management and facility management, which are often conducted by the same individual or section. Thus, the management of a building can be centrally conducted by providing the energy management system with a communication means connecting the building occupants and the building administrator. The building occupant subjective information includes information that the administrator can use to improve the management and maintenance of the building in terms other than energy.

The occupants can transmit various requests to the administrator, asking, for example, for a solution to the problem of water pipes giving out bad smell, or another asking for the replacement of a dead fluorescent bulb. In response, the administrator can send back messages to the occupant, acknowledging the receipt of a request, or explaining what will be done or has been done with regard to the problem, for example. The administrator can send various requests to the occupants, asking, for example, for lights that are not in use to be turned off, the temperature setting of the air conditioner to be lowered, or the devices with lower priority or large power consumption to be turned off so that the electric power utilization would not exceed the contract demand. In response, the occupants can send back messages acknowledging the request or explaining what has been done about the problem. In case the electric power utilization is about to exceed the contract demand, the administrator can notify the occupants of the level of emergency or the concrete name of the equipment he wishes to be terminated. The building administrator can set the communication means such that a notification is automatically transmitted in the event the energy management server determines that, based on electric power demand forecast, the electric power utilization has exceeded a dangerous level.

Hereafter a method of calculating the possibility of energy-related information analysis and the necessity for energy-related information will be described. The type of analysis result obtained from the energy-related information that is inputted is determined by the sequence or process of analysis of energy-related information in the energy management server, and, conversely, the input is determined by the output. The possibility of energy-related information analysis refers to that energy-related information which is currently unclear but that can be newly estimated from energy-related information that is newly added. The necessity for energy-related information refers to that energy-related information which is currently unclear but that should be added so as to allow the user to obtain energy-related information that he wishes to know. The energy-related information that is either inputted or outputted includes quantity, accuracy as well as type. Such information is selected from only those information that can be acquired, in light of the type of equipment existing in the building or the manner of connection as known from the building equipment/unit DB.

The energy-related information analysis possibility and the energy-related information necessity can be determined by using a DB in which the energy-related information necessary for estimation is associated with the energy-related information that is estimated. Specifically, for the energy-related information analysis possibility, the user (administrator) is asked to input energy-related information that is newly added, so that, together with the currently obtainable energy-related information, it is examined to see what energy-related information can be newly estimated using the DB. On the other hand, for the energy-related information necessity, the user (administrator) is asked to input information that is currently unclear and that is to be newly estimated, so that the type and amount of energy-related information necessary for the estimation can be examined using the DB, and the difference between that information and the currently acquired information is outputted.

By providing the DB in which the energy-related information and the energy-related information input means are associated, such cases can also be handled that energy-related information input means is inputted by user input and that it is energy-related information input means that the user wishes to know.

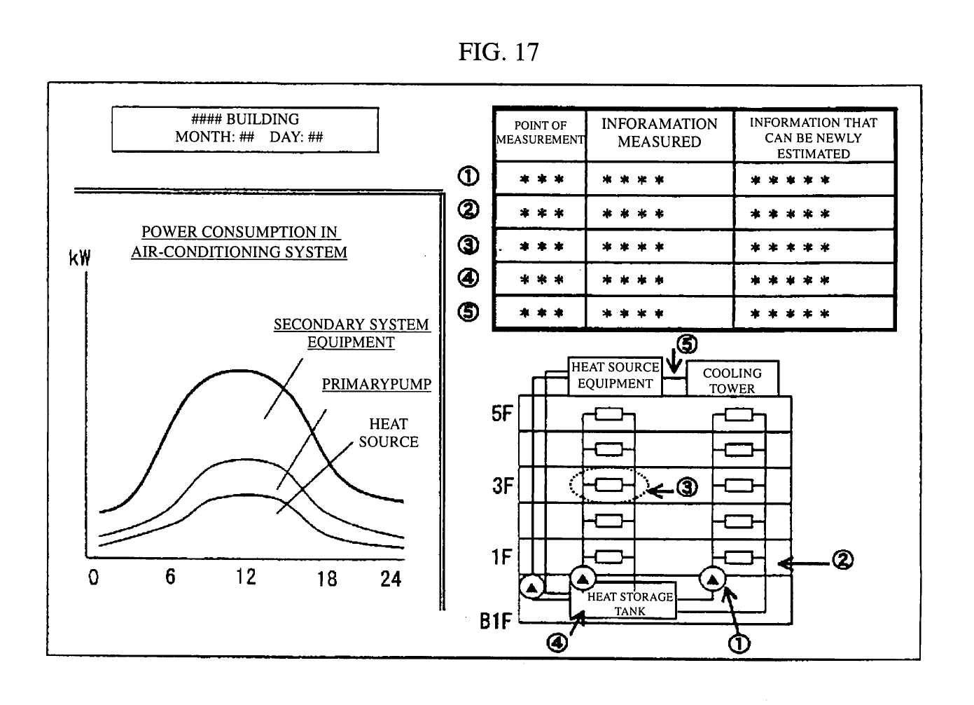

In cases where the device location information is stored in the building equipment/unit DB, the location where energy-related information input means such as measuring devices should be installed can be known. Further, by providing the building equipment/unit DB with the floor plan around devices or the design of the building, the locations inside the building where particular devices should be installed can be indicated, as shown in FIG. 17.

FIG. 17 shows on the left side information relating to the currently measured or estimated power consumption in the air-conditioning system (including secondary-system devices, primary pumps, and a heat source). Each estimated item of information (the secondary-system devices and primary pumps in the illustrated example shown in FIG. 17) is underlined such that it can be distinguished from measured items. On the other hand, the right hand side of FIG. 17 shows the measurement points for sensors or the like to be newly added (indicated by (1), (2), (3), (4), and (5) in the lower right-hand corner of FIG. 17 as location/measurement targets), in combination with the type of information that is newly estimated, in the order of decreasing cost-effectiveness in terms of energy management (in the order of (1), (2), (3), (4), and (5) in FIG. 17).

Examples of information terminals as the energy-related information input means include PDAs and cellular phones, in addition to PCs. Nowadays inter-office telephones utilize PHSs or cellular phones in many cases, so these telephones may also be employed. It is easy to locate PHSs, and these days some cellular phones are equipped with a GPS and therefore their location identifying function can be utilized. While the users of cellular phones cannot be expected to carry their phones with them all the time, the location information about someone can be accurately monitored by using a device that is carried by the user all the time, such as a wireless communication-enabled IC-card type employee ID.

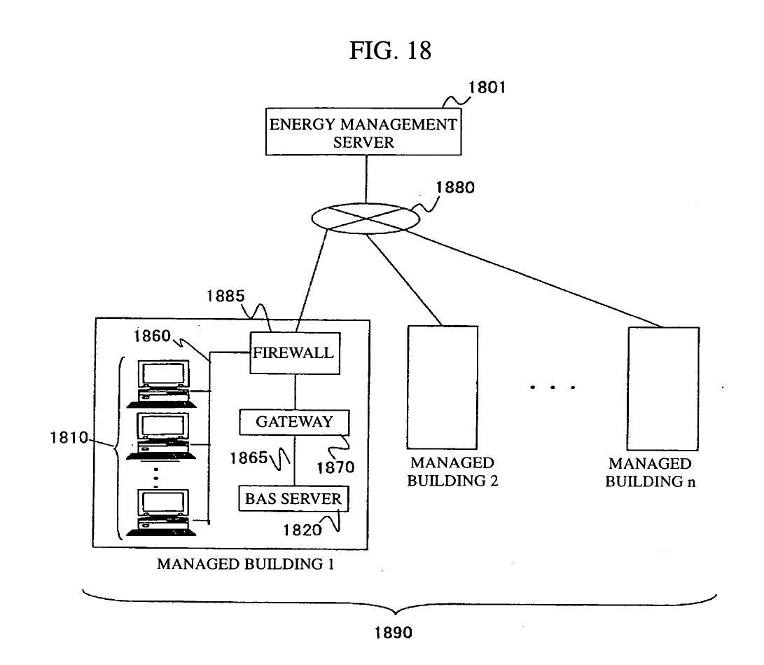

FIG. 18 shows the configuration of a remote management system utilizing the Internet. In the example of FIG. 2, one building was under the management of one energy management system. In the example of FIG. 18, a plurality of buildings are targets for management.

Information about physical quantities that are common in a region rather than inherent in a particular building, such as outside temperature, can be obtained on the Internet. For example, the temperature and humidity in a particular region can be learned from a Web site specializing in weather reports, whereby the need for sensors for measuring the temperature and humidity can be eliminated. While this can also be done in the system of FIG. 2, the technique proves more advantageous in the case of FIG. 18, where a plurality of buildings in the same region are managed, in terms of calculations. Further, sensor information such as the outside temperature can be acquired not only from Web sites but also from BAS in the neighborhood buildings. In addition to acquiring information from the outside, it is also possible to carry out a calculation process using a region as a common term, such as calculate a regional standard value of a basic unit and use as an object of comparison. The common term is not limited to region, but may also be the type of work or the structure of buildings, for example, and such a common term may be taken among a plurality of buildings.

As described above with reference to various examples, in the management of energy in a building, information for which no measurements by sensors or the like is available is inferred, and then the status of energy use is monitored and analyzed based on that inferred information. Thus, initial costs such as equipment expenses or construction cost and the costs for work stoppage due to construction, as well as running cost can be reduced. These cost-saving prospects create incentives for introducing the energy management system of the invention, thereby contributing to the saving of energy at a societal level.

Thus, in accordance with the invention, there is provided an energy management system that is easy to introduce and effective for energy-saving purposes.

1. An energy management system comprising:
energy-related information input means for the input of predetermined energy-related information;
energy-related information storage means for storing said energy-related information; and
energy-related information analysis means for inferring information that has not been measured, from said energy-related information.

2. The energy management system according to claim 1, wherein said energy-related information input means comprises:
equipment operation information input means for the input of equipment operation information, which is information about the operation of equipment related to a building; and/or
physical quantity measurement value input means for the input of a physical quantity measurement value indicating the state of a predetermined portion of the inside or outside of said building, or a change in said state.

3. The energy management system according to claim 1, wherein said energy-related information input means comprises building occupant subjective information input means for the input of building occupant subjective information indicating the perceptions of a person inside the building.

4. The energy management system according to claim 1, wherein said energy-related information analysis means comprises:
purpose-by-purpose breakdown analysis means for estimating a purpose-by-purpose breakdown of the amount of energy use such as that of electric power; and/or
parameter estimation means for estimating parameters for a calculation formula related to energy consumption, such as the amount of energy use, air-conditioning heat load, heat circuit, and power circuit.

5. The energy management system according to claim 1, wherein said energy-related information analysis means comprises physical quantity estimation means for estimating a physical quantity that has not been measured.

6. The energy management system according to claim 1, wherein said energy-related information analysis means comprises equipment operation state estimation means for estimating the state of operation of equipment that has not been measured.

7. The energy management system according to claim 1, wherein said energy-related information analysis means comprises numeric pattern estimation means for estimating a numeric pattern that can be expressed as a function relating to energy consumption and which takes time as an argument, such as an equipment operation ratio, equipment load ratio, energy use amount, or the number of occupants.

8. The energy management system according to claim 1, wherein said energy-related information analysis means comprises inefficiency analysis means for estimating the location where there is an inefficient use of energy, and the extent or cause thereof.

9. The energy management system according to claim 1, wherein said energy-related information analysis means comprises spatial state estimation means for estimating the state of a space, such as the atmospheric temperature, utilization rate of a room, or the effectiveness of air conditioning.

10. The energy management system according to claim 1, further comprising a building equipment/unit database for storing information relating to a building and equipment/unit, such as the structure or attributes of the building, the specification or characteristics of equipment/unit.

11. The energy management system according to claim 1, further comprising analysis content input means for requesting or designating the content of processing by said energy-related information analysis means.

12. The energy management system according to claim 1, further comprising energy-related information display means for displaying said energy-related information or the result of processing by said energy-related information analysis means.

13. The energy management system according to claim 1, further comprising equipment control means for controlling equipment related to the building, using the result of analysis by said energy-related information analysis means as an input.

14. The energy management system according to claim 1, further comprising energy-related information analysis possibility calculation means that calculates, upon the input of the type or amount of energy-related information that is newly added or the type or amount of the energy-related information input means, the type, amount, or accuracy of information that is currently unknown but which can be either newly estimated based on the result of analysis or by which estimation accuracy can be improved.

15. The energy management system according to claim 1, further comprising energy-related information necessity calculation means for calculating the type, amount or point of measurement of energy-related information that is to be newly added or the energy-related information input means, upon the input of the type of energy-related information that is currently unknown but that is desired to be newly estimated.

16. The energy management system according to claim 14, wherein said energy-related information analysis possibility calculation means gives priority to the output from an economical viewpoint.

17. The energy management system according to claim 1, further comprising:
building administrator-side contact means for an administrator of a building occupant-side contact means; and
building occupant-side contact means for an occupant of said building, wherein
said administrator and said occupant can send a notice, a request, or a response to a request between each other using said means.

18. The energy management system according to claim 1, wherein said energy-related information input means comprises a terminal such as a personal computer coupled to a network, wherein the operation information about each terminal is inputted as said energy-related information.

19. A method of managing energy in a managed object, comprising the steps of inputting measured information related to energy consumption and/or available information, and analyzing the inputted information to obtain information that has not been measured.

20. A system for managing energy in a managed object, said system comprising:
input means for the input of measured information related to energy consumption and/or available information; and
analyzing means for analyzing the inputted information.

21. The energy management system according to claim 15, wherein said energy-related information necessity calculation means gives priority to the output from an economical viewpoint.
